(19) United States
(12) Patent Application Publication
(10) Pub. No.: US 2022/0075694 A1
(43) Pub. Date: Mar. 10, 2022

(54) AUTOMATIC RECLAMATION OF RESERVED RESOURCES IN A CLUSTER WITH FAILURES

(71) Applicant: VMware, Inc., Palo Alto, CA (US)

(72) Inventors: Duncan EPPING, Helmond (NL); Frank DENNEMAN, Purmerend (NL); Cormac HOGAN, County Cork (IE)

(73) Assignee: VMware, Inc., Palo Alto, CA (US)

(21) Appl. No.: 17/015,054

(22) Filed: Sep. 8, 2020

(51) Int. Cl. G06F 11/14; G06F 9/4401

(52) U.S. Cl. CPC G06F 11/1417; G06F 2201/85; G06F 2201/815; G06F 9/442

(57) ABSTRACT

When a failure occurs at a host in a cluster of hosts in a virtualized computing environment, virtualized computing instances that were running on the failed host are restarted on the active host(s) in the cluster. Resources to enable the restart of the virtualized computing instances are made available by powering off virtualized computing instances that are running on the active hosts. Determination of which virtualized computing instances to power off and to power on can be performed based on power off settings and restart priority levels that are configured for the virtualized computing instances.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualized computing instances such as virtual machines (VMs) running different operating systems (OSs) may be supported by the same physical machine (e.g., referred to as a host). Each virtual machine is generally provisioned with virtual resources to run an operating system and applications. The virtual resources may include central processing unit (CPU) resources, memory resources, storage resources, network resources, etc.

In many virtualized computing environments, test and development workloads may be mixed with production workloads. As an example, test and development workloads in a virtualized computing environment may be implemented as one or more VMs running software that is being debugged. Production workloads in the virtualized computing environment may be implemented as one or more other VMs that perform normal and routine day-to-day tasks/operations, such as business processes etc. Users (including system administrators) mix these two types of workloads so as to use the available resources (e.g., memory/storage capacity, processors, etc.) as optimally as possible and so as to reduce the total cost of ownership/use of the virtualized computing environment.

In some situations, a virtualized computing environment is run close to maximum capacity such that most of the resources are being utilized for the workloads.

During normal operations, running close to or at maximum capacity does not pose any significant problems. However, when a failure occurs in host(s) in the virtualized computing environment and workloads on those host(s) need to be restarted at other host(s), it is possible that insufficient resources are available to enable the workloads to be restarted at the other host(s).

### BRIEF DESCRIPTION OF DRAWINGS

FIG. 1 is a schematic diagram illustrating an example virtualized computing environment that can implement an automatic emergency response (AER) technique;

FIG. 2 is a diagram illustrating a first example scenario for the AER technique in the virtualized computing environment of FIG. 1;

FIG. 3 is a diagram illustrating a second example scenario for the AER technique in the virtualized computing environment of FIG. 1;

FIG. 4 is a diagram illustrating a third example scenario for the AER technique in the virtualized computing environment of FIG. 1; and

FIG. 5 is a flowchart of an example method to perform the AER technique in the virtualized computing environment of FIG. 1.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

The present disclosure addresses drawbacks described above that are associated with restarting virtualized computing instances (VCIs) such as VMs and containers on a host in a virtualized computing environment when insufficient resources are available after a failure occurs. An automatic emergency response (AER) system/method is provided that allows users to specify which virtualized computing instance(s) can be powered off in a case where insufficient resources are available within a cluster to power-on (restart) higher priority virtualized computing instances impacted by the failure. The powering off of relatively lower priority virtualized computing instances enables available resources to be provided to relatively higher priority virtualized computing instances so that such relatively higher priority virtualized computing instances can be powered on to utilize the provided resources.

### Computing Environment

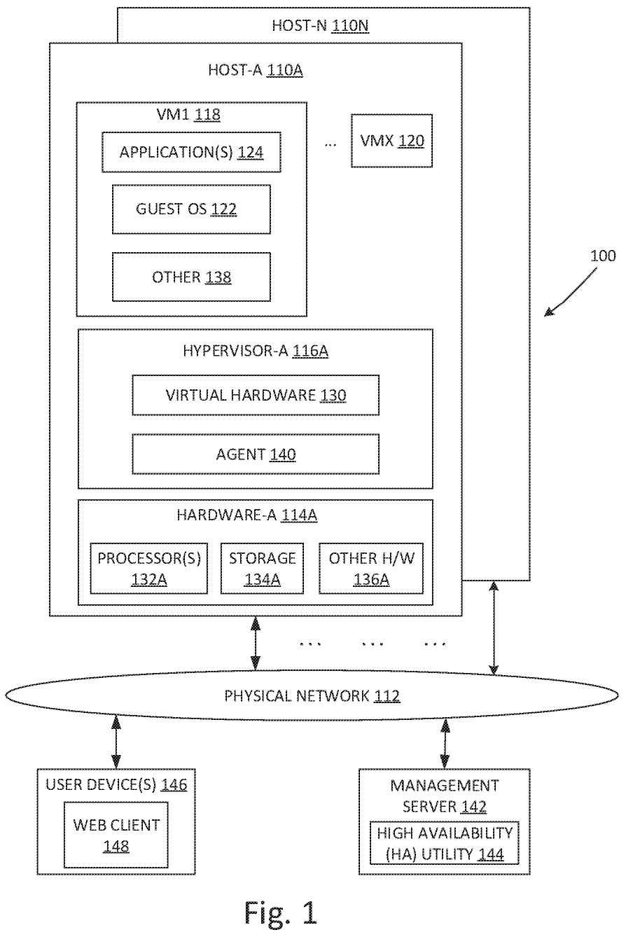

To further explain the details of the AER system/method and how the AER system/method addresses the issues associated with resource availability when powering on virtualized computing instances after a failure, reference is first made herein to FIG. 1, which is a schematic diagram illustrating an example virtualized computing environment 100 that can implement an AER technique. Depending on the desired implementation, virtualized computing environment 100 may include additional and/or alternative components than that shown in FIG. 1.

In the example in FIG. 1, the virtualized computing environment 100 includes multiple hosts, such as host-A 110A . . . host-N 110N that may be inter-connected via a physical network 112, such as represented in FIG. 1 by interconnecting arrows between the physical network 112 and host-A 110A . . . host-N 110N. Examples of the physical network 112 can include a wired network, a wireless network, the Internet, or other network types and also combinations of different networks and network types. For simplicity of explanation, the various components and features of the hosts will be described hereinafter in the context of the host-A 110A. Each of the other host-N 110N can include substantially similar elements and features.

The host-A 110A includes suitable hardware 114A and virtualization software (e.g., a hypervisor-A 116A) to support various virtual machines (VMs). For example, the host-A 110A supports VM1 118 . . . VMX 120. In practice, the virtualized computing environment 100 may include any number of hosts (also known as a computing devices, host computers, host devices, physical servers, server systems, physical machines, etc.), wherein each host may be supporting tens or hundreds of virtual machines. For the sake of simplicity, the details of only the single VM1 118 is shown and described herein.

VM1 118 may be a guest VM that includes a guest operating system (OS) 122 and one or more guest applications 124 (and their corresponding processes) that run on top of the guest OS 122. VM1 118 may include other elements 138, such as agents, code and related data (including data structures), engines, etc., which will not be explained herein in further detail, for the sake of brevity.

The hypervisor-A 116A may be a software layer or component that supports the execution of multiple virtualized computing instances. The hypervisor-A 116A may run on top of a host operating system (not shown) of the host-A 110A or may run directly on hardware 114A. The hypervisor 116A maintains a mapping between underlying hardware 114A and virtual resources (depicted as virtual hardware 130) allocated to VM1 118 and the other VMs. The hypervisor-A 116A may include an agent 140 that communicates with a management server 142. The agent 140 may be configured to perform, for example, reporting information associated with the host-A 110A and its VMs to a management server 142, such as identifying VMs that are running on the host-A 110A, which resources are being used by the VMs, an amount of resources that are reserved for use by the VMs, an amount of available (un-reserved) resources, etc.

Hardware 114A in turn includes suitable physical components, such as central processing unit(s) (CPU(s)) or processor(s) 132A; storage device(s) 134A; and other hardware 136A such as physical network interface controllers (NICs), storage disk(s) accessible via storage controller(s), etc. Virtual resources (e.g., the virtual hardware 130) are allocated to each virtual machine to support a guest operating system (OS) and application(s) in the virtual machine, such as the guest OS 122 and the application(s) 124 (e.g., a word processing application, accounting software, a browser, etc.) in VM1 118. Corresponding to the hardware 114A, the virtual hardware 130 may include a virtual CPU, a virtual memory (including the guest memory 138), a virtual disk, a virtual network interface controller (VNIC), etc. According to various embodiments described herein, the AER system/method determines which VMs to restart and power down after a failure, based on the availability of the resources (e.g., the virtual hardware 130) that may be allocated to support the restarting of virtual machines.

The management server 142 of one embodiment can take the form of a physical computer with functionality to manage or otherwise control the operation of host-A 110A . . . host-N 110N, including determining when certain hosts have failed. In some embodiments, the functionality of the management server 142 can be implemented in a virtual appliance, for example in the form of a single-purpose VM that may be run on one of the hosts in a cluster or on a host that is not in the cluster. The functionality of the management server 142 may be accessed via one or more user devices 146 that are operated by a system administrator. For example, the user device 146 may include a web client 148 (such as a browser-based application) that provides a user interface operable by the system administrator to access the management server 142, such as for purposes of identifying failed hosts, determining resource requirements and utilization, performing the AER method (described later below, including setting restart priority levels, configuring power off settings for VMs, etc.), troubleshooting, performing security/maintenance tasks, and performing other management-related operations.

The management server 142 may be communicatively coupled to host-A 110A . . . host-N 110N (and hence communicatively coupled to the virtual machines, hypervisors, agents, GMM modules, hardware, etc.) via the physical network 112. In some embodiments, the functionality of the management server 142 may be implemented in any of host-A 110A . . . host-N 110N, instead of being provided as a separate standalone device such as depicted in FIG. 1.

The host-A 110A . . . host-N 110N may be configured as a datacenter that is managed by the management server 142. The host-A 110A . . . host-N 110N may form a single cluster of hosts, which together are located at the same geographical site. Other deployment configurations are possible. For instance, in a stretched cluster configuration, two or more hosts are part of the same logical cluster but are located in separate geographical sites.

Depending on various implementations, one or more of the physical network 112, the management server 142, and the user device(s) 146 can comprise parts of the virtualized computing environment 100, or one or more of these elements can be external to the virtualized computing environment 100 and configured to be communicatively coupled to the virtualized computing environment 100.

When a failure occurs (e.g., the host-A 110A becomes inoperative), a high availability (HA) utility 144 attempts to power on (restart) the impacted VMs (VM1 118 . . . VMX 120) on the remaining other hosts in the cluster. However, the HA utility 144 (and the respective hypervisors at these other hosts) can only restart the VMs when sufficient free (and unreserved) resources are available within the cluster to permit the restart. The agent 140 may report (to the HA utility 144) the active VMs on the host, the resource utilization of the VMs, the amount of reserved and un-reserved resources etc. For instance, the VM1 118 on the failed host-A 110A might require 7 GB of memory to restart/operate. Some other and currently active host in the same cluster might have 50 GB of memory, of which 45 GB are reserved for currently running VMs on that active host and for other uses (and so unavailable for use for restarting failed VMs from failed hosts), thereby leaving 5 GB of memory as unreserved/available. This information is reported by the agent 140 to the HA utility 144. Hence, the failed VM1 118 is not restarted by the HA utility 144 on that active host since there is insufficient memory resources (e.g., 5 GB) to support the 7 GB requirement of the VM1 118 from the failed host-A 110A.

In some embodiments of the virtualized computing environment 100, the management server 142 can specify an amount of “performance degradation that can be tolerated”. Thus in the foregoing example, VM1 118 from the failed host can be possibly restarted using only the 5 GB of memory available on the active host, if the system administrator (via the management server 142) has specified that VM1 118 can be restarted and operate with less than 7 GB of memory resources and has specified that a substantial performance degradation associated with operating at that lower amount of 5 GB of memory can be tolerated. However, this feature to specify an amount of performance degradation that can be tolerated is not practical in many situations—for instance, some critical workloads have strict resource requirements that need to be met in order to restart and operate adequately after a failure. As will be further described later below, the AER system/method addresses this issue by enabling non-critical workloads to be powered off in a scenario where critical workloads cannot be restarted during a failure as a result of resource shortages.

Furthermore as an example with respect to a stretched cluster deployment configuration wherein workloads are deployed in a single logical cluster that spans two distinct geographic sites, 50% of the resources are reserved so as to guarantee that every workload can be restarted when a full site failure occurs at one of the sites. This reservation of such a large amount of resources, for allocation to workloads in the event of a failure, is inefficient since such resources generally remain unutilized unless and until a failure occurs.

Furthermore, virtual computing environments that combine test and development workloads with production workloads can result in a situation where production workloads are impacted (not available) after a failure. This is because insufficient resources are available to restart production workloads on the remaining site after a full failure is experienced at the other site, since the remaining site is continuing to run both test and development workloads and its own production workloads, and therefore has insufficient available (unreserved) resources to support restarting the production workloads that were running on the failed site.

### AER System/Method

To address the foregoing and other issues, an embodiment of the AER system/method enables users to specify which VMs can be powered off when there are insufficient resources available to restart VMs (production workloads) that are impacted as a result of a failure of one or more hosts. The VMs that can be powered off can include test and production workloads and/or other type of workloads that are deemed to be less critical relative to the production workloads to be restarted.

As an initial consideration, some virtual computing environments have a mechanism to define priority levels for restarting VMs, referred to herein as a restart priority or restart priority level. For instance, the HA utility 144 in the virtual computing system 100 can assign the following six (6) restart priority levels as listed below:
(1) Highest
(2) High
(3) Medium
(4) Low
(5) Lowest
(6) Disabled (Do not restart)

Various implementations may provide more or less (and/or different) restart priority levels than the 6 restart priority levels listed above. The restart priority levels specify the order in which VMs are to be restarted as a result of a failure, and each VM is assigned with a respective restart priority level. VMs with “highest” restart priority levels are restarted first; VMs with “lowest” restart priority levels are restarted last, and VMs with “disabled” restart priority levels are not restarted.

An example of a VM with a “highest” restart priority level is a network security workload or other type of critical workload that needs to be restarted quickly. An example of a VM with a “lowest” restart priority level is a test and production workload or other type of workload wherein restart can be delayed for a relatively longer length of time. An example of a VM with a “medium” restart priority level is a routine business workload that can be delayed but should be timely restarted. An example of a VM with a “disabled” restart priority level is a workload running obsolete applications and which is used infrequently (if at all).

However, even if such restart priority levels are in place to specify a sequence/order for VMs to restart, there is no guarantee that a critical VM (e.g., having a restart priority level of “highest”) or any other VM will be able to restart at all. For instance, such VM(s) will not be able to restart if no resources are available for the VM(s) to use, despite the fact that the VMs have a “highest” restart priority level.

Explained in another way, the HA utility 144 may have an admission control feature that sets aside (reserves) resources for use by VMs that need to restart in the event of a failure. If, however, more failures occur than the admission control feature was configured to tolerate (e.g., the number of failures exceed the capacity of the resources set aside by the admission control feature for use in restarting VMs), the result is that VMs cannot be restarted due to a lack of resources. This leads to a situation where relatively unimportant VMs are available (e.g., test and development workloads continue to run on the active hosts), but business-critical production VMs from the failed hosts are unavailable (e.g., are unable to restart on the active hosts). Therefore, the AER system/method of one embodiment solves this problem by powering off currently running VMs on the active host(s) so that the HA utility 144 can restart VMs on the active host(s) which are more important that the currently running VMs.

With the AER system/method, the user (e.g., a system administrator) uses the management server 142 to specify whether a currently running workload (VM) can be powered off or not powered off for AER when a failure occurs and VMs from the failed host(s) are to be restarted. In one example implementation, the following powering off options/settings are available for configuration into VMs by the management server 142:
Will Power Off, when needed.
May Power Off, when needed.
Never Power off (can be a default setting)

In some implementations, whether a VM is assigned a power off setting of “Will Power Off” (e.g., mandatory power off), “May Power Off” (e.g., optional power off), or “Never Power Off” (e.g., mandatory keep powered on) may be based on business logic, in that the most critical workloads (e.g., VMs performing network security) can be assigned with the “Never Power Off” setting, relatively less critical workloads (VMs performing routine day-to-day business processes) can be assigned with the “May Power Off” setting, and the least critical workloads (e.g., test and development workloads/VMs) can be assigned with the “Will Power Off” setting. In some implementations, the particular power off setting assigned to some VMs can be based on preferences of the user, alternatively or additionally to being based on business logic. For instance, the user may have some reason to keep a VM operational and therefore assigns a “Never Power Off” setting to that VM, even though that VM may not necessarily be performing business-critical tasks.

According to the AER system/method, if a situation occurs where VMs from the failed host(s) cannot be restarted due a lack of available unreserved resources in the active host(s), the HA utility 144 will first power off VMs on the active host(s) that are configured with the “Will Power Off” setting. The HA utility 144 will power off as many VMs on the active host(s) as needed to be able to restart all workloads from the failed host(s) with restart priority levels from “highest” to “lowest”. After all VMs on the active host(s) that have been configured with the “Will Power Off” settings have been powered off, but there are still insufficient available resources on the active host(s) to restart all remaining workloads from the failed host(s), then the HA utility 144 will continue with powering off all VMs on the active host(s) that are configured with the “May Power Off” setting. Again, the HA utility 144 will power off as many VMs on the active host(s) as needed to be able to restart the remainder of the VMs from the failed host(s) that need to be restarted.

If there are no VMs on the active host(s) that are left to power off, the HA utility 144 issues a warning (to be viewed by the system administrator) that all VMs on the active host(s) that were allowed to power off have been powered off, and that insufficient unreserved resources are available to restart the remaining VMs from the failed host(s).

Furthermore, if a situation occurs where VMs from the failed host(s) that are configured with the “Never Power Off” setting are all restarted, by powering off a selection of VMs on the active host(s) that are configured with the “Will Power Off” setting, then the HA utility 144 attempts to restart VMs from the failed host(s) that are configured with the “May Power Off” setting by powering off VMs on the active host(s) that are configured with the “Will Power Off” setting.

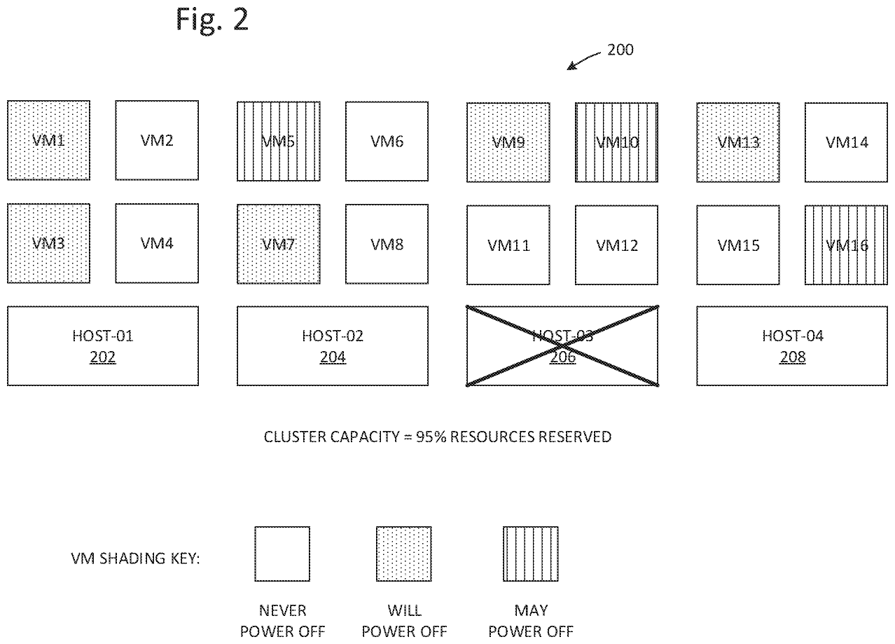

FIGS. 2-4 illustrate three example scenarios that explain the above operations of the AER system/method (AER technique) in further detail. It is understood that FIGS. 2-4 are merely examples, and that the AER system/method can be applied to other scenarios that are a modification of or otherwise different from the three illustrated example scenarios.

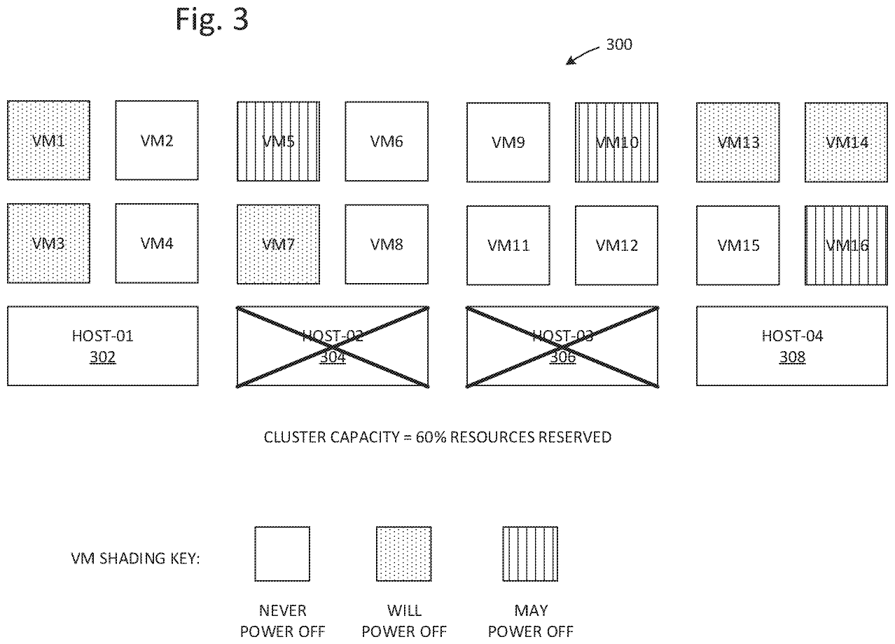

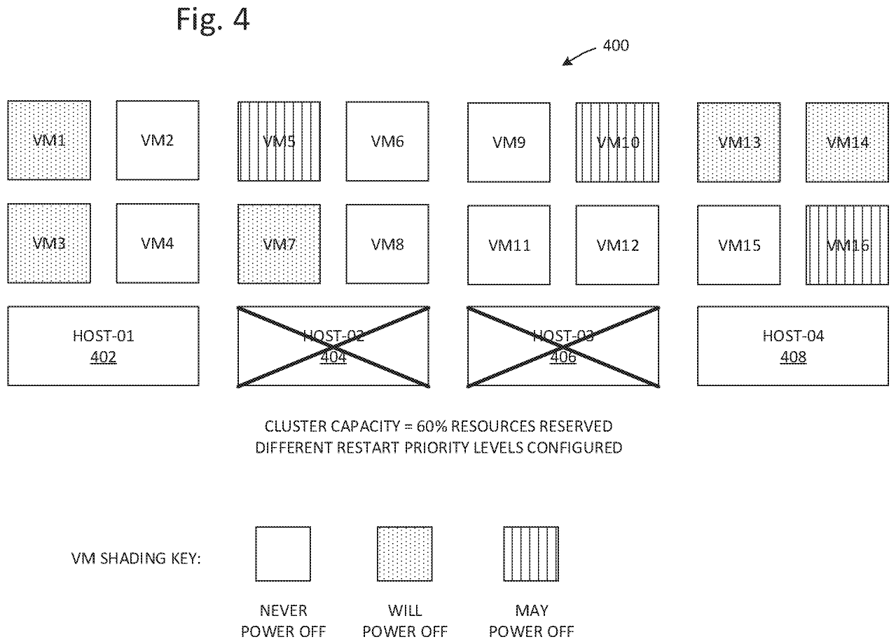

FIG. 2 is a diagram illustrating a first example scenario for the AER technique in the virtualized computing environment 100 of FIG. 1. In FIG. 2 (and similarly in FIGS. 3 and 4), a cluster 200 having four hosts is shown, including host-01 202, host-02 204, host-03 206, and host-04 208. Each host has four VMs running on the host, such as VM1-VM4 on the host-01 202, VM5-VM8 on the host-02 204, VM9-VM12 on the host-03 206, and VM13-VM16 on the host-04 208.

In the first example scenario of FIG. 2 (and similarly in FIGS. 3 and 4), a VM shading key is shown, wherein the style of shading for each VM represents the power off setting that has been configured for each VM. For instance, white shading (no shading) represents VMs that have been configured with the “Never Power Off” setting; dotted shading represents VMs that have been configured with the “Will Power Off” setting; and vertical hatch shading represents VMs that have been configured with the “May Power Off” setting.

Furthermore in the first example scenario of FIG. 2, the admission control feature is disabled (e.g., no resources are set aside in advance for use in restarting VMs in the event of a failure), and all VMs are assumed to have the same memory and processor resource requirements. It is also assumed for purposes of this example that all of the VMs have the same restart priority level configured for the VM (e.g., all VMs may be configured with the “medium” restart priority level and/or other restart priority level such that there is no specific sequence that dictates which VMs must be restarted before other VMs are restarted). The first example scenario of FIG. 2 will use memory as a resource, but the first example scenario can be applied to other types of resources, such as processor requirements.

Also for the cluster 200, 95% of the resources are reserved to support the currently running VMs. Thus, if each host has 50 GB of resources, 95% of those resources (47.5 GB) are currently reserved and in use by the currently running VMs and 5% (2.5 GB) are unreserved/available resources. Since each host has four running VMs, this means that each running VM utilizes 47.5/4 GB=11.875 GB.

The HA utility 144 then detects that a failure has occurred at host-03 206 (represented by an X placed on host-03 206 in FIG. 2), and creates a list of VMs from host-03 206 that may need to be restarted (powered on), which in this case are VM9-VM12 on host-03 206 that are impacted by the failure. The HA utility 144 then determines that there are insufficient unreserved resources in the other hosts (host-01 202, host-02 204, and host-04 208) to power on the four VMs from the failed host-03 206. Specifically and as noted above, each VM requires 11.875 GB but each of the other hosts only has 2.5 GB available, and the admission control feature was not enabled to set aside any further resources for use in restarting VMs from failed hosts.

Therefore, the HA utility 144 creates a list of active/running VMs on the active host-01 202, host-02 204, and host-04 208 that are configured with the “Will Power Off” setting and with the “May Power Off” setting. For the active hosts shown in FIG. 2, VM1, VM3, VM7, and VM13 are configured with the “Will Power Off” setting, and VM5 and VM16 are configured with the “May Power Off” setting. Hence, the HA utility 144 will power off VM1, VM3, VM7 (three VMs), and will correspondingly restart (power on) VM10, VM11, and VM12 (three VMs) at the active hosts in place of the powered off three VMs. VM1, VM3, VM7 may be powered off simultaneously or in sequence, and VM10, VM11, and VM12 may also be powered on simultaneously or in some sort of sequence so long as the required amount of resources have been made available as the VM(s) are powered on.

The HA utility 144 will then issue a warning (which can be seen by the system administrator that accesses the management server 142 via the user device 146 in FIG. 1) that the fourth VM (VM9) has not been restarted as a result of lack of unreserved resources. More specifically, VM9 is configured with the “Will Power Off” setting and the active VM13 is also configured with the “Will Power Off” setting. Since both of these VMs are configured equally (both are configured with the “Will Power Off” setting), no action is taken to power on VM9. Explained in another way, the HA utility 144 does not favor one of these VMs over another VM in terms of whether or not to power off one of them and to power on the other one, since they are equally configured with the same power off setting.

Some further observations can be made from the first example scenario of FIG. 2. One observation is that the VMs (VM2, VM4, VM6, VM8, VM14, and VM15 on the active hosts) that are configured with the “Never Power Off” setting, are indeed not powered off in favor of powering on VM(s) from the failed host-03 206. Another observation is that the VMs (VM5 and VM16 on the active hosts) that are configured with the “May Power Off” setting, are not powered off by the AER system/method since there was a sufficient number of other VMs (VM1, VM3, and VM7 on the active hosts) that were available to be powered off in order to enable VM10, VM11, and VM12 to restart.

FIG. 3 is a diagram illustrating a second example scenario for the AER technique in the virtualized computing environment 100 of FIG. 1. The second example scenario shares some similarities with respect to the previous first example scenario of FIG. 2, in that a cluster 300 includes four hosts (host-01 302, host-02 304, host-03 306, and host-04 308) that each support four VMs. The same VM shading key is used in FIGS. 2-4 to represent the power off settings for each of the VMs.

Also similar with respect to the first example scenario of FIG. 2, the second example scenario of FIG. 3 involves VMs that are all assumed to have the same memory and processor resource requirements, and all of the VMs have the same restart priority level configured for the VM. The second example scenario of FIG. 3 uses memory as a resource, but the second example scenario can be applied to other types of resources, such as processor requirements.

For the cluster 300, 60% of the resources are reserved to support the currently running VMs. Thus, if each host has 50 GB of resources, 60% of those resources (30 GB) are currently reserved and in use by the currently running VMs and 40% (20 GB) are unreserved/available resources. Since each host has four running VMs, this means that each running VM utilizes 30/4 GB=7.5 GB. So, each host has unreserved/available resources to support the restart of two additional VMs (e.g., 7.5 GB×2=15 GB, which is within the 20 GB that is available at each host).

The HA utility 144 then detects that a failure has occurred at host-02 304 and host-03 306 (represented by an X placed on host-02 304 and host-03 306 in FIG. 3), and creates a list of VMs from host-02 304 and host-03 306 that may need to be restarted (powered on), which in this case are VM5-VM8 on host-02 304 and VM9-VM12 on host-03 306 that are impacted by the failure.

The HA utility 144 then powers on VMs from the failed hosts until the available resources at the active hosts can no longer support restarting additional VMs. More specifically, the HA utility 144 powers on VM6, VM8, VM9, and VM11 (which are prioritized since they are configured with the “Never Power Off” setting). Two of these VMs can be restarted at host-01 302, while the other two VMs can be restarted at host-04 308, thereby leaving 5 GB available at each host (e.g., 20 GB−2×7.5 GB=5 GB) after the restart.

Since the restarting of VM6, VM8, VM9, and VM11 has now effectively used up the available unreserved resources at host-01 302 and host-04 308, the HA utility 144 then creates a list of VMs on these active hosts that are configured as “Will Power Off” and “May Power Off”, so as to free up resources to power on the remaining VMs from the failed hosts. The HA utility 144 accordingly powers off VM1, VM3, and VM13 (which are all configured with the “Will Power Off” setting), and powers on VM12, VM5, and VM10 in their place at host-01 302 and host-04 308.

The HA utility 144 does not power off VM14 on host-04 308 and does not power on VM7 from the failed host-02 304, since both are equally configured with the “Will Power Off” setting—that is, the HA utility 144 does not favor powering off one VM for the benefit of another VM when these two VMs have equal power off settings. As such, the HA utility 144 issues a warning (via the management server 142 accessible by the system administrator) that VM7 has not been restarted due to a lack of available resources.

FIG. 4 is a diagram illustrating a third example scenario for the AER technique in the virtualized computing environment 100 of FIG. 1. In FIG. 4, a cluster 400 having four hosts is shown, including host-01 402, host-02 404, host-03 406, and host-04 408. Each host has four VMs running on the host. In general, the configurations/features/description from the previous example in FIG. 3 are applicable and the same as that in FIG. 4. For example, each VM has 50 GB of resources, with 60% of these resources being reserved for active VMs and thus 40% (20 GB) available at each host to support restarts of VMs that each utilize 7.5 GB. A difference (as noted in FIG. 4) between the cluster 400 and the cluster 300 of FIG. 3 is that the VMs in the cluster 400 have different restart priority levels configured for the VMs.

For instance, the previous second example scenario in FIG. 3 (and also in FIG. 2) had the same restart priority level, such as “medium”, for all of the VMs. However, in the third example scenario of FIG. 4, VM6 and VM8 are configured with the “high” restart priority level; VM7 is configured with the “disabled” restart priority level; and the other VMs in the cluster 400 all have the same “medium” restart priority level.

The HA utility 144 detects that a failure has occurred at host-02 404 and host-03 406 (shown by the X placed on these hosts in FIG. 4), and creates a list of VMs on the failed hosts that may need to be powered on at the active hosts. The HA utility 144 therefore powers on the VMs with the “high” restart priority first, which in this case are VM6 and VM8. These two VMs are powered on, for example, at host-01 402 that has 20 GB of resources that are available, thereby leaving 5 GB available after VM6 and VM8 are restarted at host-01 402.

Next, the HA utility 144 powers on the VMs with the “medium” restart priority level, which in this case are VM9 and VM11. These VMs may be powered on in sequence according to order of name (e.g., “9” comes before “11”), or they may be powered on simultaneously. These two VMs are powered on, for example, at host-04 408 that has 20 GB of resources that are available, thereby leaving 5 GB available after VM9 and VM11 are restarted at host-04 408. At this point, host-01 402 and host-04 408 no longer have sufficient available resources to enable restarting any further remaining VMs.

Therefore, the HA utility 144 creates a list of VMs on host-01 402 and host-04 408 that are configured with the “Will Power Off” and “May Power Off” settings. These VMs are VM1 and VM3 on host-01 402 and VM13 and VM14 on host-04 408, which are all configured with the “Will Power Off” setting (4 total VMs), and VM16 on host-04 408 that is configured with the “May Power Off” setting.

The HA utility 144 accordingly powers off VM1, VM3, and VM13 that have the “Will Power Off” setting, and powers on VM12, VM5, and VM10 in their place at the active hosts (e.g., three VMs powered off, and three VMs powered on). One observation with these powering off/on operations is that the VMs being powered off are less prioritized (e.g., configured with the “Will Power Off” setting), as compared to the VMs being powered on (e.g., VM12 configured with the “Never Power Off” setting, and VM5 and VM10 configured with the “May Power Off” setting). Another observation is that VM12 may be powered on before VM5 and VM10, given that VM12 is prioritized due to its “Never Power Off” setting.

The HA utility 144 does not restart VM7, since VM7 is configured with the “disabled” restart priority level. The HA utility 144 can send a warning, via the management server 142, to the system administrator, if it is appropriate to notify the system administrator that VM7 has not been restarted.

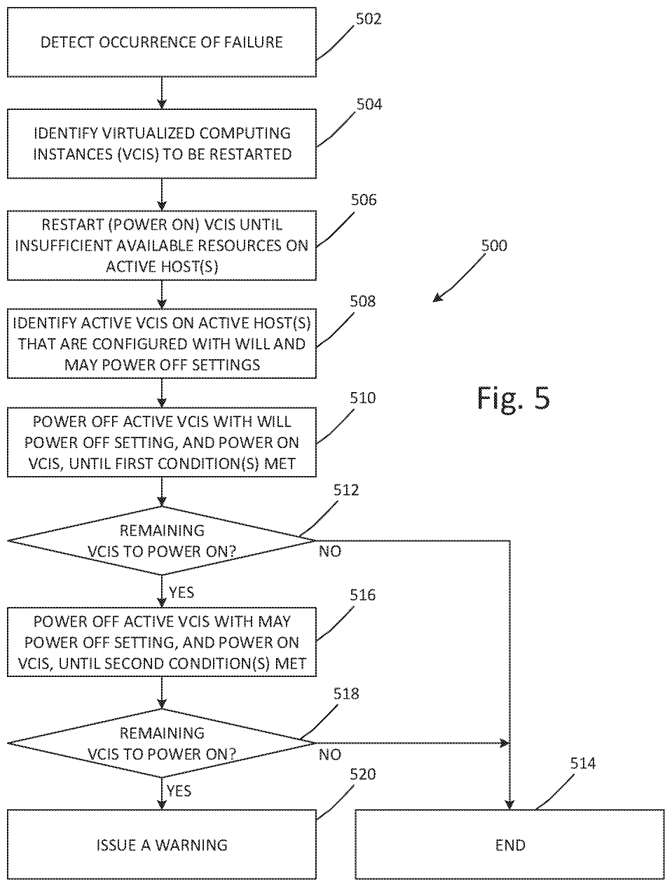

FIG. 5 is a flowchart of an example method 500 perform the AER technique in the virtualized computing environment 100 of FIG. 1. Example method 500 may include one or more operations, functions, or actions illustrated by one or more blocks, such as blocks 502 to 520. The various blocks of the method 500 and/or of any other process(es) described herein may be combined into fewer blocks, divided into additional blocks, supplemented with further blocks, and/or eliminated based upon the desired implementation. In one embodiment, the operations of the method 500 and/or of any other process(es) described herein may be performed in a pipelined sequential manner. In other embodiments, some operations may be performed out-of-order, in parallel, etc.

According to one embodiment, the method 500 may be performed by the management server 142 and its elements (such as the HA utility 144) in cooperation with the agent 140 and/or other elements (such as hypervisors) of hosts managed by the management server 142. In other embodiments, various other elements in a computing environment may perform, individually or cooperatively, the various operations of the method 500.

At a block 502 (“DETECT OCCURRENCE OF FAILURE”), the HA utility 144 detects that one or more hosts in a cluster managed by the management server 142 has failed. For example in FIG. 2, the HA utility 144 detects that host-03 206 in the cluster 200 of FIG. 2 has failed, or that host-02 304 and host-03 306 have failed in the cluster 300 of FIG. 3, or that host-02 404 and host-03 406 have failed in the cluster 400 of FIG. 4.

The block 502 may be followed by a block 504 (“IDENTIFY VIRTUALIZED COMPUTING INSTANCES (VCIS) TO BE RESTARTED)”), wherein the HA utility 144 identifies and creates a list of VMs on the failed host(s) that potentially need to be restarted. The HA utility 144 also identifies the resource requirements of these VMs. The VMs that were running on the failed host(s) and their resource requirements may have been provided previously to the HA utility 144 by the agent 140 on the failed host(s), prior to the failure.

The block 504 may be followed by a block 506 (“RESTART (POWER ON) VCIS UNTIL INSUFFICIENT AVAILABLE RESOURCES ON ACTIVE HOST(S)”), wherein the HA utility 144 instructs the hypervisor(s) on the active host(s) to power on the VMs (which were previously running on the failed host(s)), until insufficient available resources remain on the active host(s). Referring back to the example scenarios of FIGS. 3 and 4, two of the failed VMs can be restarted on each of the active hosts-01 302/402 and host-04 308/408, since these hosts had 40% unreserved resources that are available to restart two failed VMs per host. In the example scenario of FIG. 2, the active hosts did not have any available unreserved resources, and so the operation of block 504 is not performed in the example scenario of FIG. 2.

The block 506 may be followed by a block 508 (“IDENTIFY ACTIVE VCIS ON ACTIVE HOST(S) THAT ARE CONFIGURED WITH WILL AND MAY POWER OFF SETTINGS”) in which the HA module 144 obtains (via the agent 140) a list of active VMs on each active host and the respective power off settings of the VMs, such as “Will Power Off”, “May Power Off”, and “Never Power Off”. The block 508 may be followed by a block 510 (“POWER OFF ACTIVE VCIS WITH WILL POWER OFF SETTING, AND POWER ON VCIS, UNTIL FIRST CONDITION(S) MET”) in which the HA utility 144 instructs the hypervisor(s) at the active host(s) to power off active VMs that have been configured with the “Will Power Off” setting, and then VMs from the failed hosts are powered on to replace the powered off VMs.

The active VMs (with the “Will Power Off” setting) are powered off and the VMs from the failed host(s) are powered on in their place at the block 510, until one or more first conditions are met. For instance, a first condition may be that a number of VMs (with the “Will Power Off” setting) are powered off until the amount of resources that they free up (e.g., become unreserved) is sufficient to enable a restart of the remaining failed VMs—the next active VM with the “Will Power Off” setting therefore does not need to be powered off. Another example of the first condition is that a number of VMs (with the “Will Power Off” setting) are powered off until the next active VM has the same/equal power off setting (e.g., the “Will Power Off” setting) as the remaining VM(s) to power on—since both of these VMs are equally configured with the “Will Power Off” setting, no action need be taken to power off one of the VMs in favor of powering on the other VM.

The block 510 may be followed by a block 512 (“REMAINING VCIS TO POWER ON?”) wherein the HA utility 144 determines whether there are any remaining VMs from the failed host(s) that need to be powered on. If there are no further VMs to power on (“NO” at the block 512), then the method 500 ends at a block 514. However, if there are further VMs from the failed host(s) that need to be powered on (“YES” at the block 512), then the method 500 proceeds to a block 516 (“POWER OFF ACTIVE VCIS WITH MAY POWER OFF SETTING, AND POWER ON VCIS, UNTIL SECOND CONDITION(S) MET”).

Specifically at the block 516 (and similar to the block 510), the HA utility 144 instructs the hypervisor(s) on the active host(s) to power off active VMs (with the “May Power Off” setting) and the VMs from the failed host(s) are powered on in their place, until one or more second conditions are met. For instance, a second condition may be that a number of VMs (with the “May Power Off” setting) are powered off until the amount of resources that they free up (e.g., become unreserved) is sufficient to enable a restart of the remaining failed VMs—the next active VM with the “May Power Off” setting therefore does not need to be powered off. Another example of the second condition is that a number of VMs (with the “May Power Off” setting) are powered off until the next active VM has the same/equal power off setting (e.g., the “May Power Off” setting) as the remaining VM(s) to power on—since both of these VMs are equally configured with the “May Power Off” setting, no action need be taken to power off one of the VMs in favor of powering on the other VM,

The block 516 may be followed by a block 518 (“REMAINING VCIS TO POWER ON?”) wherein the HA utility 144 determines whether there are any further remaining VMs from the failed host(s) that need to be powered on. If there are no further VMs to power on (“NO” at the block 518), then the method 500 ends at the block 514. However, if there are further VMs from the failed host(s) that need to be powered on (“YES” at the block 518), then the method 500 proceeds to a block 520 (“ISSUE A WARNING”) wherein the HA utility 144 issues a warning to the system administrator to indicate that there are remaining VMs that need to be restarted but are unable to be restarted, due to insufficient resources on the active host(s).

### Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1-5. For example, computing devices capable of acting as host devices may be deployed in virtualized computing environment 100.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances (VCIs) may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system. Moreover, some embodiments may be implemented in other types of computing environments (which may not necessarily involve a virtualized computing environment), wherein it would be beneficial to power on/off certain computing elements after a failure, dependent on resource availability and priorities of the computing elements.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other instructions to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

1. A method in a virtualized computing environment to restart virtualized computing instances in response to a failure, the method comprising:
configuring virtualized computing instances, which run on hosts arranged in a cluster, with power off settings, wherein the power off settings include a mandatory power off setting, an optional power off setting, and a mandatory power on setting;
detecting a failure of a host in the cluster; and
in response to detecting the failure of the host in the cluster:
identifying first virtualized computing instances, from the failed host, that are to be restarted;
restarting the first virtualized computing instances, on an active host in the cluster;
identifying second virtualized computing instances, which are running on the active host in the cluster, that are configured with the mandatory power off setting;
identifying third virtualized computing instances, which are running on the active host in the cluster, that are configured with the optional power off setting;
creating a list of the identified second virtualized computing instances and the identified third virtualized computing instances; and
powering off at least some of the second virtualized computing instances from the list created that are configured with the mandatory power off setting, and restarting at least some of the first virtualized computing instances at the active host in place of the powered off second virtualized computing instances, until one or more first conditions are met.

2. The method of claim I, further comprising:
identifying at least one further remaining first virtualized computing instance that is to be restarted;
determining that the active host has no further virtualized computing instances to power off to enable a restart of the at least one further remaining first virtualized computing instance at the active host; and
generating an alert to indicate that the at least one further remaining first virtualized computing instance is not restarted due to insufficient resources at the active host.

3. The method of claim 1, wherein restarting the at least some of the first virtualized computing instances in place of the powered off second virtualized computing instances includes restarting the at least some of the first virtualized computing instances based on a restart priority level that ranges from highest to lowest, and wherein first virtualized computing instances with relatively higher restart priority levels are restarted before first virtualized computing instances with relatively lower restart priority levels, wherein the one or more first conditions includes at least one further remaining first virtualized computing instance that is to be restarted is configured with the mandatory power off setting and at least one further remaining second virtualized computing instance that is to be powered off is configured with the mandatory power off setting.

4. The method of claim 1, wherein:
the first virtualized computing instances that are restarted are configured with the mandatory power on setting or with the optional power off setting, and
the first virtualized computing instances configured with the mandatory power on setting are restarted before the first virtualized computing instances with the optional power off setting are restarted.

5. The method of claim 1, further comprising prior to powering off the second virtualized computing instances:
determining that the active host has available unreserved resources to enable restarting one or more of the first virtualized computing instances at the active host; and
restarting, at the active host, the one or more of the first virtualized computing instances using the available unreserved resources, until there are insufficient unreserved resources at the active host to enable restarting further first virtualized computing instances.

6. The method of claim 1, further comprising:
maintaining in a powered off state, rather than restarting at the active host, virtualized computing instances from the failed host that are configured with the mandatory power off setting.

7. The method of claim 1, further comprising:
identifying remaining first virtualized computing instances that are to be restarted; and
in response to identifying remaining first virtualized computing instances that are to be restarted, powering off at least some of the third virtualized computing instances from the list created that are configured with the optional power off setting, and restarting at least some of the remaining first virtualized computing instances at the active host in place of the powered off third virtualized computing instances, until one or more second conditions are met, wherein the cluster is a logical cluster that spans a first geographic site and a second geographic site.

8. A non-transitory computer-readable medium having instructions stored thereon, which in response to execution by one or more processors in a virtualized computing environment, cause the one or more processors to perform operations to restart virtualized computing instances in response to a failure, wherein the operations comprise:
configuring virtualized computing instances, which run on hosts arranged in a cluster, with power off settings, wherein the power off settings include a mandatory power off setting, an optional power off setting, and a mandatory power on setting;
detecting a failure of a host in the cluster; and
in response to detecting the failure of the host in the cluster;
identifying first virtualized computing instances, from the failed host, that are to be restarted;
restarting the first virtualized computing instances, on an active host in the cluster;
identifying second virtualized computing instances, which are running on the active host in the cluster, that are configured with the mandatory power off setting;
identifying third virtualized computing instances, which are running on the active host in the cluster, that are configured with the optional power off setting;
creating a list of the identified second virtualized computing instances and the identified third virtualized computing instances; and
powering off at least some of the second virtualized computing instances from the list created that are configured with the mandatory power off setting, and restarting at least some of the first virtualized computing instances at the active host in place of the powered off second virtualized computing instances, until one or more first conditions are met.

9. The non-transitory computer-readable medium of claim 8, wherein the operations further comprise:
identifying at least one further remaining first virtualized computing instance that is to be restarted;
determining that the active host has no further virtualized computing instances to power off to enable a restart of the at least one further remaining first virtualized computing instance at the active host; and
generating an alert to indicate that the at least one further remaining first virtualized computing instance is not restarted due to insufficient resources at the active host.

10. The non-transitory computer-readable medium of claim 8, wherein restarting the at least some of the first virtualized computing instances in place of the powered off second virtualized computing instances includes restarting the at least some of the first virtualized computing instances based on a restart priority level that ranges from highest to lowest, and wherein first virtualized computing instances with relatively higher restart priority levels are restarted before first virtualized computing instances with relatively lower restart priority levels, wherein the one or more first conditions includes at least one further remaining first virtualized computing instance that is to be restarted is configured with the mandatory power off setting and at least one further remaining second virtualized computing instance that is to be powered off is configured with the mandatory power off setting.

11. The non-transitory computer-readable medium of claim 8, wherein:
the first virtualized computing instances that are restarted are configured with the mandatory power on setting or with the optional power off setting, and
the first virtualized computing instances configured with the mandatory power on setting are restarted before the first virtualized computing instances with the optional power off setting are restarted.

12. The non-transitory computer-readable medium of claim 11, wherein the operations further comprise:
determining that the active host has available unreserved resources to enable restarting one or more of the first virtualized computing instances at the active host; and
restarting, at the active host, the one or more of the first virtualized computing instances using the available unreserved resources, until there are insufficient unreserved resources at the active host to enable restarting further first virtualized computing instances.

13. The non-transitory computer-readable medium of claim 8, wherein the operations further comprise:
maintaining in a powered off state, rather than restarting at the active host, virtualized computing instances from the failed host that are configured with the mandatory power off setting.

14. The non-transitory computer-readable medium of claim 8, wherein the operations further comprise:
identifying remaining first virtualized computing instances that are to be restarted; and
in response to identifying remaining first virtualized computing instances that are to be restarted, powering off at least some of the third virtualized computing instances from the list created that are configured with the optional power off setting, and restarting at least some of the remaining first virtualized computing instances at the active host in place of the powered off third virtualized computing instances, until one or more second conditions are met, wherein the cluster is a logical cluster that spans a first geographic site and a second geographic site.

15. A management server in a virtualized computing environment, the management server comprising:
a processor; and
a non-transitory computer-readable medium coupled to the processor and having instructions stored thereon, which in response to execution by the processor, cause the processor to perform operations to restart virtualized computing instances in response to a failure, wherein the operations comprise:
configure virtualized computing instances, which run on hosts arranged in a duster, with power off settings, wherein the power off settings include a mandatory power off setting, an optional power off setting, and a mandatory power on setting;
detect a failure of a in the cluster; and
in response to detecting the failure of the host in the cluster:
identify first virtualized computing instances, from the failed host, that are to be restarted;
restart the first virtualized computing instances, on an active host in the cluster;
identify second virtualized computing instances, which are running on the active host in the cluster, that are configured with the mandatory power off setting;
identify third virtualized computing instances, which are running on the active host in the cluster, that are configured with the optional power off setting;
create a list of the identified second virtualized computing instances and the identified third virtualized computing instances; and
power off at least some of the second virtualized computing instances from the list created that are configured with the mandatory power off setting, and restart at least some of the first virtualized computing instances at the active host in place of the powered off second virtualized computing instances, until one or more first conditions are met.

16. The management server of claim 15, wherein the operations further comprise:
identify at least one further remaining first virtualized computing instance that is to be restarted;
determine that the active host has no further virtualized computing instances to power off to enable a restart of the at least one further remaining first virtualized computing instance at the active host; and
generate an alert to indicate that the at least one further remaining first virtualized computing instance is not restarted due to insufficient resources at the active host.

17. The management server of claim 15, wherein restart of the at least some of the first virtualized computing instances in place of the powered off second virtualized computing instances includes a restart the at least some of the first virtualized computing instances based on a restart priority level that ranges from highest to lowest, and wherein first virtualized computing instances with relatively higher restart priority levels are restarted before first virtualized computing instances with relatively lower restart priority levels, wherein the one or more first conditions includes at least one further remaining first virtualized computing instance that is to be restarted is configured with the mandatory power off setting and at least one further remaining second virtualized computing instance that is to be powered off is configured with the mandatory power off setting.

18. The management server of claim 15, wherein:
the first virtualized computing instances that are restarted are configured with the mandatory power on setting or with the optional power off setting, and
the first virtualized computing instances configured with the mandatory power on setting are restarted before the first virtualized computing instances with the optional power off setting are restarted.

19. The management server of claim 18, wherein the operations further comprise:
determine that the active host has available unreserved resources to enable restarting one or more of the first virtualized computing instances at the active host; and
restart, at the active host, the one or more of the first virtualized computing instances using the available unreserved resources, until there are insufficient unreserved resources at the active host to enable restarting further first virtualized computing instances.

20. The management server of claim 15, wherein the operations further comprise:
maintain in a powered off state, rather than restarting at the active host, virtualized computing instances from the failed host that are configured with the mandatory power off setting.

21. The management server of claim 15, wherein the operations further comprise:
identify remaining first virtualized computing instances that are to be restarted; and
in response to identifying, remaining first virtualized computing instances that are to be restarted, power off at least sonic of the third virtualized computing instances from the list created that are configured with the optional power off setting, and restarting at least some of the remaining first virtualized computing instances at the active host in place of the powered off third virtualized computing instances until one or more second conditions are met, wherein the cluster is a logical cluster that spans a first geographic site and a second geographic site.
